(19) United States
(12) Patent Application Publication
(10) Pub. No.: US 2008/0168340 A1
(43) Pub. Date: Jul. 10, 2008

(54) Method of Efficiently Managing File Location Awareness for Client Applications

(75) Inventor: Soobaek Jang, Southbury, CT (US)

Correspondence Address: CAHN & SAMUELS, LLP, 1100 17th STREET, NW, SUITE 401, WASHINGTON, DC, 20036, US

(73) Assignee: INTERNATIONAL BUSINESS MACHINES CORPORATION, Armonk, NY (US)

(21) Appl. No.: 11/620,300

(22) Filed: Jan. 5, 2007

(51) Int. Cl. G06F 17/00

(52) U.S. Cl. 715/206

(57) ABSTRACT

A system and method for sorting and organizing file locations when saving website bookmarks, and downloading, uploading and saving files from or to a website. The system automatically generates and displays a file path for each bookmark or file based on selectable options, including domain, file type, user configurable options, user behavior or defaults. The system provides a bookmark mechanism by creating and presenting a folder based on these options and defaults, and using that folder as the default “save to” folder for files from that domain or containing a keyword in the title or body of the file. The system is also configurable to provide a user selected folder as the default “save to” location when options configured by the user are met. The system further provides a file storage mechanism by creating and presenting a “save to” folder for each file being saved based on the options and defaults.

### I. FIELD OF THE INVENTION

This invention relates to a system and method for automatically sorting and organizing website bookmarks and/or file pathways. The invention further relates to a system and method for automatically sorting and organizing file locations when downloading, uploading and saving files from or to a website or email. The bookmarks and file locations are automatically generated and displayed based on user selectable criteria and/or the context of the situation.

### II. BACKGROUND OF THE INVENTION

The World Wide Web (web or internet) consists of a web of remote, linked computer networks. This web of computer networks, referred to as the internet, facilitates the remote exchange of information and communication between its users. Since its creation, the internet has experienced tremendous growth as evidenced by an ever-increasing number, diversity and quality of information and resources available to its users. This growth not only strengthens and expands the information and resources available on the internet, but also contributes to individual's increased usage of the internet as users are able to quickly search for and retrieve this information.

Computer networks designed to operate in the internet environment are generally designed to operate on a client/server platform. The information made available on the internet is stored on the various remote computers or servers. These servers allow other computers or clients to access the information stored on the servers via the internet. The client typically utilizes a software program or “browser” that is stored on the client computer to request information from the server. After receiving the request, the server responds by sending the requested information to the client computer. The requested information is made available to the user in the client's browser.

Internet users often utilize the browser to search or “browse” various websites and files for information. The information on these websites is generally organized by pages (“web page”) and links. Each page and link has its own address or identification code called a Uniform Resource Locator (“URL”), which is often a long string of characters. Websites frequently contain many pages and each page may contain volumes of information. This information may be stored in various known file formats, including doc, pdf, html, xml, etc. Also, these websites often have “links” to other information or files which may be on other websites and servers.

Typically, users visit certain preferred websites and pages often. Users also frequently desire to return to a page visited while browsing. In order to return to a particular website, page or link, it is often helpful for the user to remember the URL. However, due to the number and complexity of these URLs it can be unreasonable, if not impossible, for a user to remember them all.

Similar problems also arise when users attempt to download, upload or save files from or to websites, email clients or various other file locations. Users would need to remember where to save or upload a file from for all different usages. As users use different files in various folders, and clients only remember the last file or location of the file used, the user might have to navigate multiple file paths up and down to select the one needed.

In an effort to resolve these issues, users often “bookmark” frequently visited and/or important websites and pages in order to quickly and easily locate them. Similarly, users also frequently save the file paths they use often so that they can just copy and paste those paths as needed when they download, upload, or save from/to websites and/or email clients. This is done to help the users remember or reduce the clicks of possible navigation of multiple file paths. The problem presented by current bookmark and save file mechanisms on the web and in email clients is that those mechanisms only provide users with a few generic top folders (locations) or some number of recently used folders from which to select when deciding where to bookmark a website or save a file.

The following scenario more clearly illustrates the problem presented by current bookmark and save mechanisms. A user is trying to save two types of files from a website to an appropriate file folder. The two file types are JPEG (picture) files and EXE (program) files. The user would like to save the JPEG files to the file location “c:\my pictures\” and the EXE files to the file location “c:\download\executable\”. The user finds many files throughout the website where the various files are a mixture of both JPEG and EXE files. Utilizing the currently available mechanisms, the user has to change the location of the folder each time he saves the other type of file.

This limitation applies to bookmarks, as well, when a user navigates many sites for different topics. The user has to go back and forth to locate the appropriate folder in which they want to bookmark each individual website. As an example, even though some applications (such as Mozilla and Firefox) provide a few of the most recently used folders for bookmark, they only present the last child folder (sub-folder) to the user. This mechanism works similarly when users upload files on the web or an email client.

Notwithstanding the usefulness of the above-described methods, a need still exists for a system and method for automatically sorting bookmarks and files to download, upload or save to appropriate file locations based on user customized categorization.

### III. SUMMARY OF THE INVENTION

This invention in at least one embodiment provides a method for efficiently providing a user configurable bookmark on a computer file management system, including presenting configurable setting options to the user; receiving at least one user setting option; creating bookmark folders based on the user setting options; and, presenting said bookmark folder to a user in response to a request to bookmark a web page or link based on at least the user setting options.

This invention in at least one embodiment provides a computer program product including a computer useable medium that includes a computer readable program, wherein the computer readable program when executed on a computer causes the computer to receive configurable user setting options; create bookmark folders in response to user selected setting options; and, present bookmark folders to a user in response to a request to bookmark a web page or link based on at least the user selected setting options.

This invention in at least one embodiment provides a method for organizing information on a computer, including receiving setting options from a user; arranging file paths for organizing information in response to the user setting options; and, presenting at least one file path to the user in response to a request to store a file or location based on at least the user setting options.

This invention in at least one embodiment provides a method for organizing information on a computer, including means for receiving setting options from a user; means for arranging file paths for organizing information in response to the user setting options; and, means for presenting at least one file path to the user in response to a user request to store a file or location based on the user setting options.

Given the following enabling description of the drawings, the apparatus should become evident to a person of ordinary skill in the art.

### IV. BRIEF DESCRIPTION OF THE DRAWINGS

The present invention is described with reference to the accompanying drawings, wherein:

FIG. 1 illustrates a computer system;

FIG. 2 illustrates a network of computers interconnected via the internet;

FIG. 3 illustrates a chart outlining user configuration preferences;

FIG. 4 illustrates an overview of files being downloaded based on the user configuration preferences outlined in FIG. 3;

FIG. 5 illustrates the process of creating a bookmark in accordance with an aspect of the present invention;

FIG. 6 illustrates the process of creating a file storage location in accordance with an aspect of the present invention;

FIG. 7 illustrates an exemplary file storage pop-up window in accordance with an aspect of the present invention.

### V. DETAILED DESCRIPTION OF THE DRAWINGS

In an aspect of the exemplary embodiment, the invention provides an easy and convenient method to computer users to save website bookmarks and/or download, upload and save electronic files. This aspect of the invention provides configurable options to computer users when the users attempt to bookmark websites, or download, upload, or save files from or to a website or other file location. These configurable options are selectable from a main pop-up window for both bookmark and save functions. These options may be based on user preferences, user behavior, or defaults.

In another aspect of the exemplary embodiment, the invention provides an easy and convenient method to email clients to store and attach files through email. This aspect of the invention provides similar configurable options as those provided in the bookmark and website file save aspect of the invention. Further, the method of this exemplary embodiment provides the email client with additional attributes including configuration based on sender, receiver, subject, etc. While these aspects of the exemplary embodiment of the invention are described with regard to bookmark, website files, and email files, they may well apply to all computer file management clients.

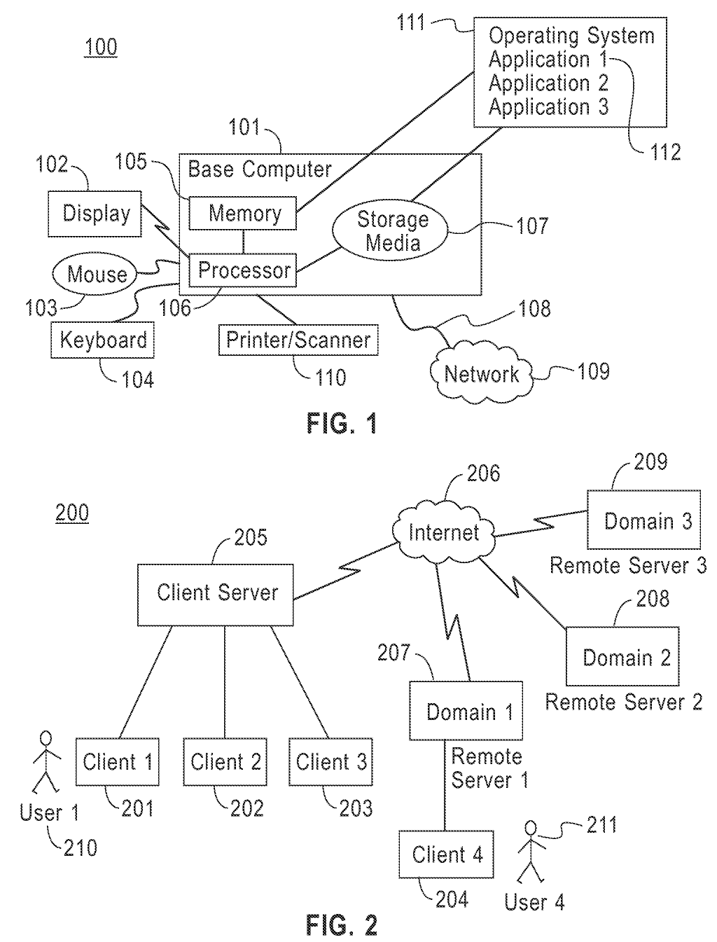

FIG. 1 depicts the elements that make up a typical computer for use in networked applications. The computer system 100 consists of a base computer 101 which comprises a processor 106, storage media such as a magnetic disk 107 and a high speed volatile main memory 105. An operating system and application programs 111, including a browser, reside on the storage media 107 and are paged into main memory 105 as needed for operations and computations performed by the processor 106. The base computer 101 may include optional peripheral devices including a video display 102, a printer or scanner 110, a keyboard 104, a pointing device (mouse) 103 and a connection 108 to a network 109. In a client environment, a user interacts with a Graphical User Interface (GUI) by using a keyboard 104 and mouse 103 in conjunction with the display of information on the display 102 under control of an application program (application 1) 112. The client application programs 111, 112 (including browser) then interact with remote users or servers by way of the network 109.

In FIG. 2, an example of an Internet system is shown. A user 210 at client 201 uses applications on his system and can interact with clients 2-4, shown at 202-204, by way of a client-server computer 205 or directly. Applications 111, 112 may be provided by each client 201-204 and/or the client server 205 or some remote servers 207-209 by way of the network 206. The user 210 at client 1 can interact with a remote user 4, shown at 211, at client 4, shown at 204, by way of the Internet 206. The client server network 200 allows Clients 1-4 to access websites and information in the form of links, files, etc. and to exchange information via email, files and other means.

The present invention allows users to more efficiently use the client-server system to search for and save files and bookmarks. For the bookmark function, the method of the present invention provides a mechanism that generates the automatic grouping of bookmarks to a folder or other storage location based on user preference, user behavior, or default settings. These grouping options create a folder for a particular domain and then use that folder as the “default” storage location for all bookmarks associated with that domain. When this option is selected, each time a user attempts to bookmark any page on the specified domain, a default folder will be presented as the “save to” folder. This option is available when no folder for that domain has been created. Similarly, another grouping option uses the current folder as the default folder for the current domain. With this option selected, the current folder is presented for all future bookmarks from the current domain. Yet another grouping option of the present invention allows users to use any other bookmark folder to default any sites of their choice.

In practice, users tend to bookmark pages or subsets of pages from the same domain into the same folder or subfolder. These bookmarks are often also based on page title, content and keywords. After selecting the bookmark option, the user will have the option of creating a bookmark folder for that domain. The user will also be presented with the option of creating subfolders. These subfolders may be selected for the context root of the URL, in addition to the page title, content, and keywords. If a domain folder already exists on the bookmark, the user will have the option of selecting that folder as well as creating a new sub-folder under the folder. Similarly, for download/upload and save files from/to sites, users can configure the default location of files by the site and/or file type.

Another solution provided by this invention is the pre-selection of file locations based on the user's behavior. For example, if a user tends to save all executable files under a certain directory, the next time the user tries to save an executable file from a website or email, they are more likely to save that file under the same directory. Therefore, showing the number of best matches on pre-defined locations for both file save and bookmark function offers a new, more efficient experience to users. The invention allows these user behavior preferences to be stored by the file type, domain, senders, etc. to define the user's preferences and automatically provide the best matches when the user requests a bookmark or file save function.

Yet another solution provided by this invention is the utilization of user's behavior to store key information. According to this aspect, the system stores key information, such as domains, file types, senders and receivers for each file upon user's action (e.g., downloading, uploading, saving, attaching files) with its stored folder. The system then generates indexes for that data (key information). Upon user's action, the system takes all available parameters (e.g., domains, file types, senders and receivers) and then generates a list of possibly desired folders from these indexes. A user may also create additional customized configurations that are set to override these behavioral indexes or provide additional behavioral indexes. Nonetheless, the behavioral indexes provide a high probability of providing users with the desired folder without any configuration on the part of the user.

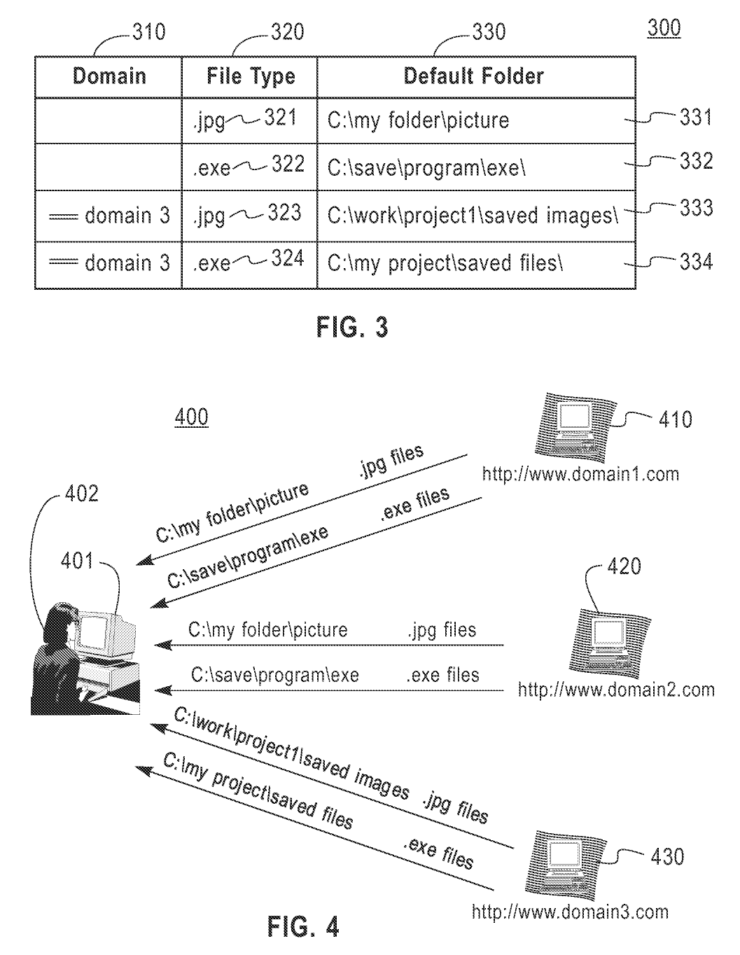

FIG. 3 outlines an exemplary chart 300 that represents user configuration settings, including domain 310, file type 320 and default folder 330, for downloaded file storage locations. Chart 300 specifies the location or default folder 330 where each file type 320 should be saved based on configurations set by the user. Chart 300 also specifies that file types 320 from certain websites or domains 310 should be saved to specific folders 330. The chart specifies that all .jpg (picture) files from any domain other than domain3 should be saved to c:\my folder\picture and all .exe (executable) files from any domain other than domain3 should be saved to c:\save\program\exe. These settings further specify that all .jpg files from domain3 should be saved to c:\work\project1\saved images\and that all .exe files from domain3 should be saved to c:\my project\saved files\.

FIG. 4 outlines an exemplary overview of the current invention based on chart 300 of FIG. 3. The overview 400 lists various websites 407-409 (domain1, domain2, domain3) and file types (.jpg, .exe) downloaded from those websites by a user 402 over the internet. The overview also includes the file path or file location where the files are saved on the user's computer 401. When utilizing the process of the present invention, the user 402 browses the internet as usual and saves bookmarks and files when needed. In the course of browsing the internet, the user may visit many different domains and may choose to download and save files from several different websites, including domain1, domain2 and domain3, as illustrated.

In this example, the user downloads both .jpg (picture) and .exe (executable) files from all three websites 407-409. domain1410 and domain2 420 both represent websites having similar user settings, based on personal use for example, and each specified file type, .jpg and .exe, may be saved to a specified location or folder for that file type. Based on the user settings, as shown in FIG. 3, all .jpg files downloaded from both domain1 410 and domain2 420 are saved to the file location c:\my folder\picture. All .exe files downloaded from both domain1 and domain2 are saved to file location c:\save\program\exe. domain3 430 represents a website having different user settings than domain1 410 and domain2 420. These settings may be based, for example, on business use. All .jpg files downloaded from domain3 430 are saved to file location c:\work\project1\saved images\. All .exe files downloaded from domain3 430 are saved to c:\my project\saved files\. These settings which are consistent with the user configurations, as outlined in FIG. 3, are stored and are automatically presented each time the user attempts to download these file types from these domains. These settings or file paths may be presented to the user in a hierarchical structure.

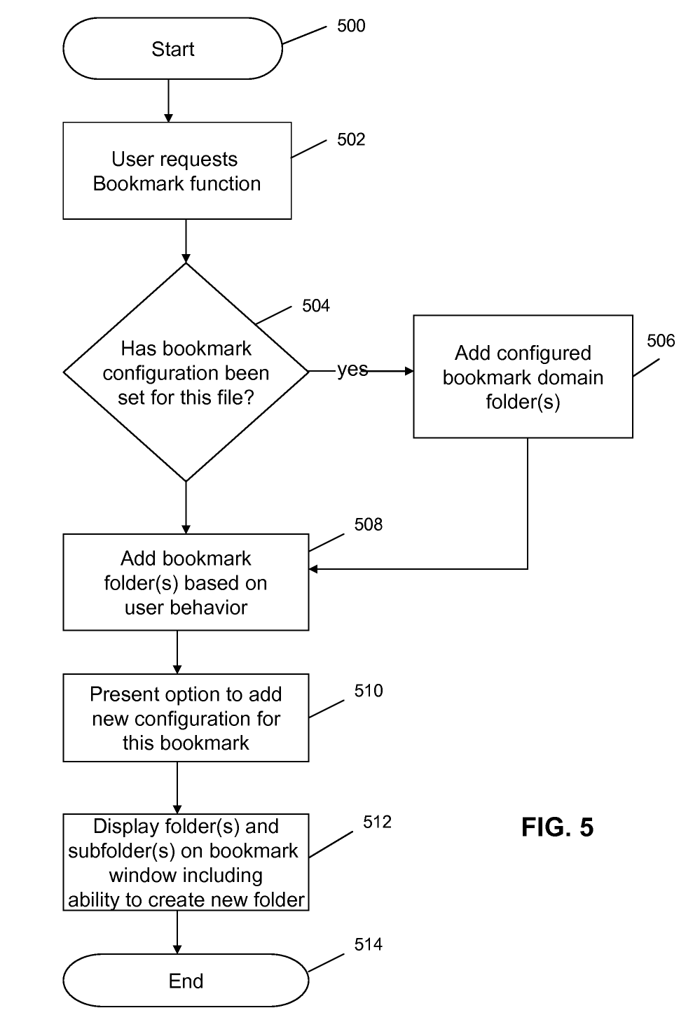

FIG. 5 outlines the process of how the file management system creates bookmark folder(s) and subfolder(s) and presents these folder(s) to a user. The process begins at step 500 with the bookmark application selected by the user. At step 502, the user requests that the bookmark function be performed. At step 504, the system determines whether a bookmark configuration has been set for the current domain. If, at step 504, it is determined that the bookmark configuration options have been set for the current domain, the process would proceed to step 506 and add configured bookmark domain folders to the list of folders that will be presented to the user. The process would then proceed to step 508. If, at step 504, it is determined that the bookmark configuration has not been set for the current domain, the process would proceed to step 508. At step 508, the system adds bookmark folders based on user behavior (e.g. domain, content, keyword, etc.). The step of adding bookmark folders based on user behavior occurs independently of whether the domain settings have been configured. The process then proceeds to step 510. At step 510, the user is presented the option of adding (or updating) a configuration for the bookmark setting. The process then proceeds to step 512 where folder(s) and subfolder(s) based on the user configurations and/or user behavior are displayed on a bookmark window for selection by the user. This bookmark window also includes the option of creating new folder(s) and subfolder(s). The process then proceeds to step 514 where the user configuration settings are saved and the process ends. These settings help determine the folders presented to the user on the next user bookmark request.

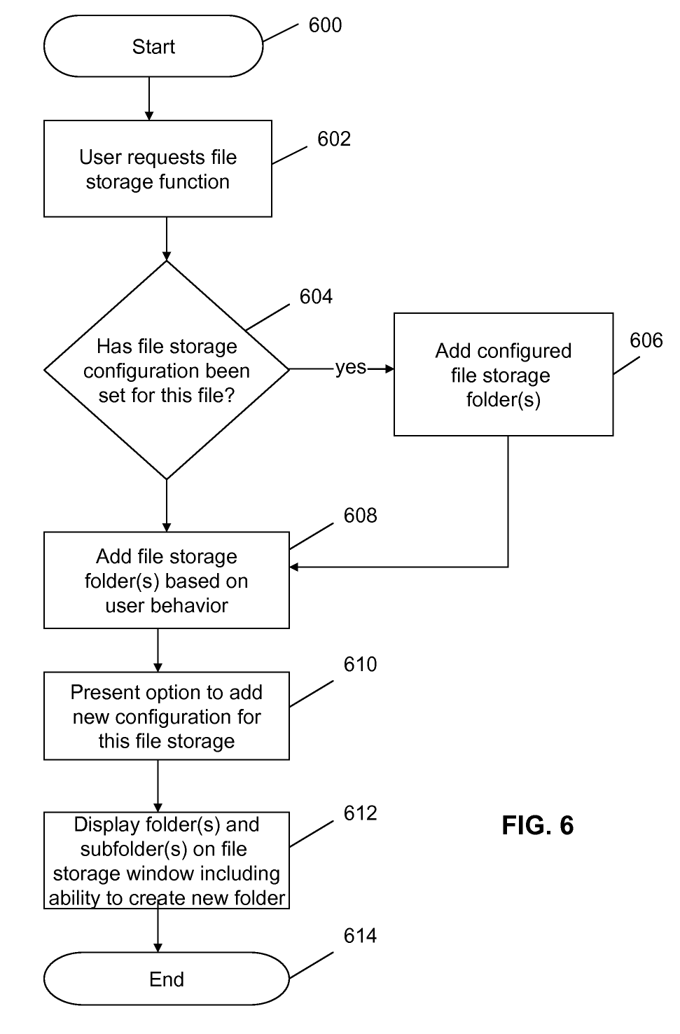

FIG. 6 outlines the process of how the file management system creates file storage folder(s) and subfolder(s) and presents these folder(s) to a user. The process begins at step 600 with the file storage application selected by the user. At step 602, the user requests that a file storage function be performed. The process then proceeds to step 604 and determines whether the file storage function configurations have been set for the current file (based on file type, domain, sender, receiver, etc.). If, at step 604, it is determined that the file storage configuration options have been set for the current file, the process proceed to step 606 and add configured file storage folders to the list of folders that will be presented to the user. The process would then proceed to step 608. If, at step 604, it is determined that the file storage configuration has not been set for the current file, the process would proceed to step 608. At step 608, the system adds file folders based on user behavior (e.g. file type, domain, sender, receiver, etc.). The step of adding file storage folders occurs independently of whether the file settings have been configured. The process then proceeds to step 610. At step 610, the user is presented the option of adding (or updating) a configuration for the file storage setting. The process then proceeds to step 612 where folder(s) and subfolder(s) based on the user configurations and/or user behavior are displayed on a file storage window for selection by the user. This file storage window also includes the option of creating new folder(s) and subfolder(s). The process then proceeds to step 614 where the user configuration settings are saved and the process ends. These settings help determine the folders presented to the user on the next user file save request.

For instance, a web developer utilizes many strings of code to perform his duties. These strings of code are often stored using lengthy file paths such as C :\MyJ2 EE\ProjectA\ProjectA_Web\JavaSource\com\ibm\webahead\intragrid\common. The developer often needs to upload these files to an application which requires the full path to be surfed before it can be attached to the file. After that the file is attached, the developer may need to attach another file. For example, this file may be for another project and is stored using the file path C:\MyPHP\ProjectQ\source\shares\a.php. Attaching this file requires the developer to surf the entire file path of the new file prior to uploading. The present invention allows users to pre-define file storage folders based on file types, domains, etc. so that the user can quickly and easily access the file without the need to surf the entire file path. This method can also be applied to email clients by defining the file location based on sender/receiver, file types, subject line, etc.

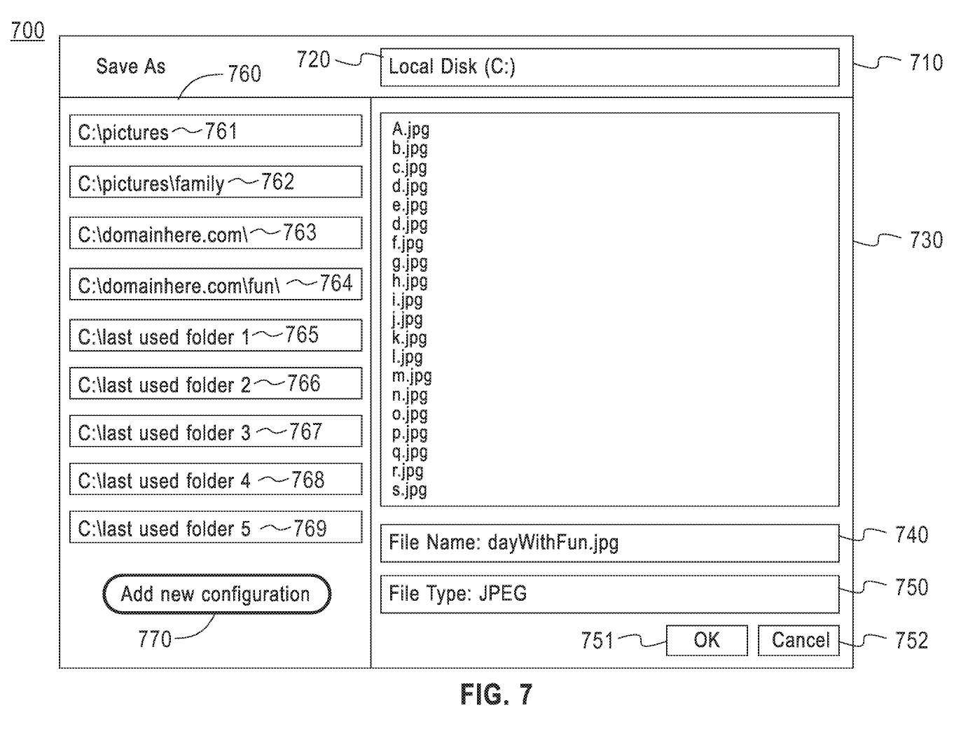

FIG. 7 illustrates an exemplary embodiment of a pop-up window for use with the file storage function. The pop-up window allows the user to select configurable setting options that manage the handling and storage of files. These options allow the user to automatically store files based on the user's preferences which may include the file type, a website or domain the file is associated with, the URL context root, keywords in the file, user behavior (e.g. frequently or last used folders), etc. The pop-up window may be divided into several areas and may include, for example, drop-down bars for selecting options. For example, the pop-up window of FIG. 7 includes a main “Save As” section 710 that includes a drop-down bar 720 that allows the user to select which drive location to save the file. Once the drive is selected, all files of the same type on that drive are listed in a “Saved Files” section 730. This section also includes a “File Name” drop-down bar 740 that lists the file name of the current file and a “File Type” drop-down bar 750 that lists the file type of the current file. The drop-down bars allow the user to maintain the current file name and type or to select a new file name and type to save the current file as.

“File Storage” folder section 760 lists several optional folders and sub-folders 761-769 for storing the current file based on file type, domain associated with the file, user behavior, etc. As an example, these folders may include one or more general file type folder(s) 761 including one or more sub-folder(s) 762. These folders are presented to the user each time the user attempts to save a file that invokes the settings. For example, each time the user attempts to save a JPEG file, picture folders and sub-folders are presented to the user. The folders may also include one or more general domain folder(s) 763 including one or more subfolder(s) 764. These folders are based on user settings for a particular website or page. Whenever the user attempts to download a file from a selected website or page these folders are presented to the user (based on the user settings). This section may also include one or more “Last Used” folders 765-769. These folders reflect the user's behavior by presenting the “last used” folders for the current file type or domain, for instance. The user has the option of selecting “Add New Configuration” 770 to display the configuration setting window and add/update the setting, “OK” 751 to save the file, or “Cancel” 752 to end the save function. These folder options allow for the automatic generation and presentation of appropriate folders so that users can quickly select appropriate folders without having to search for them.

The invention can take the form of an entirely hardware embodiment, an entirely software embodiment or an embodiment containing both hardware and software elements. In at least one exemplary embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As will be appreciated by one of ordinary skill in the art, the present invention may be embodied as a computer implemented method, a programmed computer, a data processing system, a signal, and/or computer program. Accordingly, the present invention may take the form of an entirely hardware embodiment, an entirely software embodiment or an embodiment combining software and hardware aspects. Furthermore, the present invention may take the form of a computer program on a computer-usable storage medium having computer-usable program code embodied in the medium. Any suitable computer readable medium may be utilized including hard disks, CD-ROMs, optical storage devices, carrier signals/waves, or other storage devices.

Computer program code for carrying out operations of the present invention may be written in a variety of computer programming languages. The program code may be executed entirely on at least one computing device, as a stand-alone software package, or it may be executed partly on one computing device and partly on a remote computer. In the latter scenario, the remote computer may be connected directly to the one computing device via a LAN or a WAN (for example, Intranet), or the connection may be made indirectly through an external computer (for example, through the Internet, a secure network, a sneaker net, or some combination of these).

It will be understood that each block of the flowchart illustrations and block diagrams and combinations of those blocks can be implemented by computer program instructions and/or means. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowcharts or block diagrams.

The exemplary embodiments described above may be combined in a variety of ways with each other. Furthermore, the steps and number of the various steps illustrated in the figures may be adjusted from that shown.

It should be noted that the present invention may, however, be embodied in many different forms and should not be construed as limited to the embodiments set forth herein; rather, the embodiments set forth herein are provided so that the disclosure will be thorough and complete, and will fully convey the scope of the invention to those skilled in the art. The accompanying drawings illustrate exemplary embodiments of the invention.

Although the present invention has been described in terms of particular exemplary embodiments, it is not limited to those embodiments. Alternative embodiments, examples, and modifications which would still be encompassed by the invention may be made by those skilled in the art, particularly in light of the foregoing teachings.

Those skilled in the art will appreciate that various adaptations and modifications of the exemplary and alternative embodiments described above can be configured without departing from the scope and spirit of the invention. Therefore, it is to be understood that, within the scope of the appended claims, the invention may be practiced other than as specifically described herein.

We claim:

1. A method for efficiently providing a user configurable bookmark on a computer file management system, comprising:
presenting configurable setting options to the user;
receiving at least one user setting option;
creating bookmark folders based on said at least one user setting option; and,
presenting said bookmark folder to said user in response to a request to bookmark a web page or link based on said at least one user setting option, wherein said request includes at least one bookmark for a web page or link.

2. The method according to claim 1, further comprising presenting sub-folders to said user in response to a request to bookmark a webpage or link based on at least the user setting option.

3. The method according to claim 2, wherein said bookmark folders and subfolders are presented based at least in part on user preferences.

4. The method according to claim 3, wherein said user preferences include web domain, file type, the URL context root, or keyword.

5. The method according to claim 1, wherein said bookmark folders are presented based at least in part on previously selected user preferences.

6. The method according to claim 1, wherein said bookmark folders are presented based at least in part on default settings.

7. A computer program product comprising a computer useable medium including a computer readable program, wherein the computer readable program when executed on a computer causes the computer to:
receive configurable user setting options;
create bookmark folders in response to at least one user selected setting option; and,
present bookmark folders to a user in response to a request to bookmark a web page or link based on said at least one user selected setting option, wherein said request includes at least one bookmark for a web page or link.

8. The computer program product according to claim 7, wherein the computer readable program further causes the computer to:
present sub-folders to said user in response to a request to bookmark a web page or link based on said at least one user selected setting option.

9. The method according to claim 8, wherein said bookmark folders and subfolders are presented based at least in part on user preferences.

10. The method according to claim 9, wherein said user preferences include domain, file type, the URL context root, or keyword.

11. The method according to claim 7, wherein said bookmark folders and sub-folders are presented based at least in part on previously selected user preferences.

12. The method according to claim 7, wherein said bookmark folders and sub-folders are presented based at least in part on default settings.

13. A method for organizing information on a computer, comprising:
receiving at least one setting option from a user;
arranging file paths for organizing information in response to said at least one user setting option; and,
presenting at least one file path to said user in response to a request to store a file or location based on said at least one user setting option, wherein said request includes at least one file path for a file or location.

14. The method according to claim 13, further comprising presenting multiple file paths to said user in response to a request to save a file or location based on said at least one user setting option.

15. The method according to claim 14, wherein said multiple file paths are presented based at least in part on user preferences.

16. The method according to claim 15, wherein said user preferences include web domain, file type, the URL context root, or keyword.

17. The method according to claim 13, wherein said file paths are presented based at least in part on previously selected user preferences.

18. The method according to claim 13, wherein said file paths are presented based at least in part on default settings.

19. The method according to claim 13, wherein said file paths include at least one hierarchical bookmark structure.

20. A method for organizing information on a computer, comprising:
means for receiving setting options from a user;
means for arranging file paths for organizing information in response to said user setting options; and,
means for presenting at least one file path to said user in response to a request to store a file or location based on said user setting options.
